(19) United States
(12) Patent Application Publication
(10) Pub. No.: US 2026/0111289 A1
(43) Pub. Date: Apr. 23, 2026

(54) WEB SERVICE RESOURCE SCALING

(71) Applicant: Salesforce, Inc., San Francisco, CA (US)

(72) Inventor: Jose Lejin P J, Bangalore (IN)

(21) Appl. No.: 18/924,872

(22) Filed: Oct. 23, 2024

(51) Int. Cl. G06F 9/50

(52) U.S. Cl. CPC G06F 9/5083; G06F 9/5027; G06F 2209/5022

(57) ABSTRACT

Methods, apparatuses, and computer-program products are disclosed. The method may include monitoring user interactions with web services to identify web service elements and application programming interface (API) calls associated with the web service elements. The method may include generating, based on a machine learning analysis of the user interactions, a graph database including mappings between the web service elements and the API calls, where the mappings are organized into user-based clusters. The method may include receiving natural language input that includes instructions for scaling resources and processing the natural language input to identify resource scaling rules from the instructions. The method may include adjusting resource allocation parameters for the web services based on the mappings and the identified one or more resource scaling rules.

### FIELD OF TECHNOLOGY

The present disclosure relates generally to database systems and data processing, and more specifically to web service resource scaling.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may perform resource management operations. However, such methods may be improved.

### BRIEF DESCRIPTION OF THE DRAWINGS

FIGS. 1 and 2 illustrate examples of computing environments that support web service resource scaling in accordance with aspects of the present disclosure

FIG. 2 illustrates an example of a processing system that supports web service resource scaling in accordance with aspects of the present disclosure.

FIG. 3 shows an example of a resource scaling system that supports web service resource scaling in accordance with aspects of the present disclosure.

FIG. 4 shows an example of a process flow that supports web service resource scaling in accordance with aspects of the present disclosure.

FIG. 5 shows a block diagram of an apparatus that supports web service resource scaling in accordance with aspects of the present disclosure.

FIG. 6 shows a block diagram of a scaling manager that supports web service resource scaling in accordance with aspects of the present disclosure.

FIG. 7 shows a diagram of a system including a device that supports web service resource scaling in accordance with aspects of the present disclosure.

FIG. 8 shows a flowchart illustrating methods that support web service resource scaling in accordance with aspects of the present disclosure.

### DETAILED DESCRIPTION

In contemporary web applications, managing the scaling of web service elements (also referred to as views) hosted on web page servers and APIs on representational state transfer (REST) servers presents significant challenges. Some auto-scaling mechanisms lack precision, and sub-optimally allocate resources based on actual usage patterns of both views and APIs. Also, the conditions that can be configured for scaling are static and limited to standard format. This inefficiency can lead to either over-provisioning, which wastes resources, or under-provisioning, which degrades performance. An intelligent solution to automate and optimize this process is desirable, which can result in significant cost savings.

A system may employ monitoring agents for web applications to track user interactions with views and corresponding API calls. For example, such tracking may involve tracking of different features or views of dynamic web pages, to see which views are most often used, which APIs are called, and the like. This tracking may result in production of a graph database that includes user clusters, representing relationships between views and API usage. An artificial intelligence (AI) or machine learning algorithm may analyze the graph database and identify patterns and correlations between web service views and API calls and may automatically scale web service resources to better correspond with actual or predicted usage as compared to other approaches. Further, administrators may provide rules/procedures in plain English to dictate to the system what scaling changes to make without detailed knowledge. A generative AI model may interpret these plain language statements and translate them into actionable instructions for guiding the auto-scaling operations, making it easy to use for administrators.

Aspects of the present disclosure are initially described in the context of computing environments, messaging interfaces, dashboard interfaces, systems, and process flows. Aspects of the present disclosure are further illustrated by and described with reference to apparatus diagrams, system diagrams, and flowcharts that support techniques for processing queries related to network security. Aspects of the present disclosure are further illustrated by and described with reference to system diagrams and flowcharts that support techniques for web service resource scaling

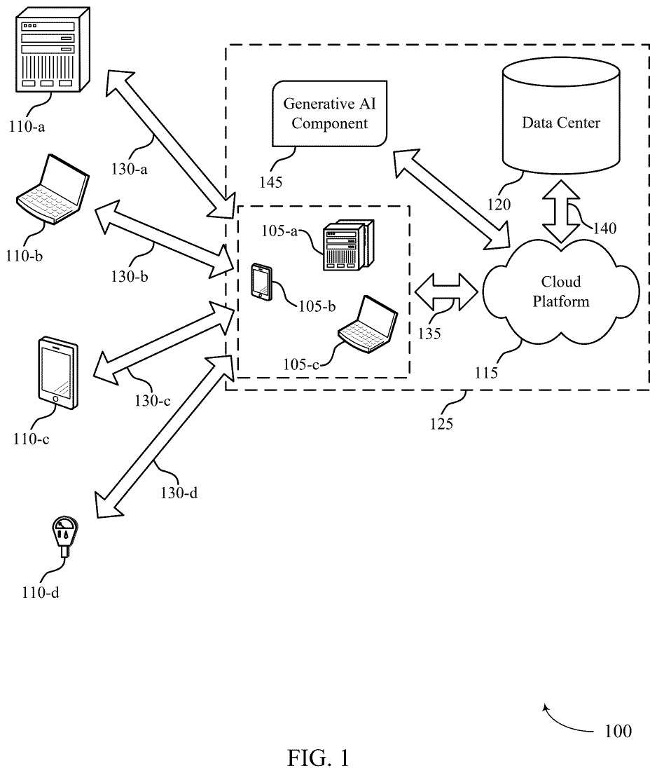

FIG. 1 illustrates an example of a system 100 for cloud computing that supports web service resource scaling in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using APIs) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In various implementations, the models and/or modules described herein may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques along with training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Additionally, or alternatively, the system 100 may support the use of a large language model (generative AI model), such as the generative AI component 145. In some examples, a generative AI component 145 may also be referred to as any of an AI, a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In some examples, the cloud platform 115 may monitor user interactions (e.g., associated with cloud clients 105) with web services (e.g., of the cloud platform 115 or another platform) to identify web service elements (also referred to herein as views, web views or web service views) and API calls associated with the web service elements. cloud platform 115 may generate (e.g., based on a machine learning analysis of the user interactions, such as an analysis that utilizes the generative AI component 145), a graph database that includes mappings between the web service elements and the API calls. In some examples, the mappings may be organized into user-based clusters that associate various API calls and web service elements. In some examples, the 115 may receive natural language input (e.g., from a cloud client 105, an administrator, or other source) that includes instructions for scaling resources. The cloud platform 115 may process the natural language input (e.g., using the generative AI component 145) to identify resource scaling rules from the instructions. The cloud platform 115 may adjust one or more resource allocation parameters for the web services based on the mappings and the identified one or more resource scaling rules.

In some approaches, it may be challenging to manage resources for web services. At times, the demand on the system may outweigh the capacity of the resources and at other times, excessive resources may not be utilized. Further, such approaches may not be precise enough to make changes that reflect the actual usage of the resources in the most optimal way. Further, such approaches may be limited to static or limited formats, techniques, and results. Further, such approaches may offer only limited interfaces or methods of interaction, often involving specialized knowledge, training, and time investment to understand and make changes. As such, performance and resource utilization may be reduced, costs may increase, and overall effectiveness of the web services may suffer.

By monitoring the user interactions to determine usage on a per-view (e.g., web service element) level and a per-API level, more granular and detailed information about actual usage of the web services may be obtained, allowing for better resources allocation and utilization. By generating a graph database that indicates such monitored information, the system may discover additional connections, influences, operations, patterns, trends, or information associated with the usage of the web services that may not otherwise be apparent, increasing the accuracy and efficiency of resource allocation and utilization. By allowing natural language input to establish resource allocation or utilization rules or adjustments, the interface between users and the complicated resource allocation systems may be simplified and streamlined, involving less technical details and allowing operations, rules, and information to be employed with the system more quickly. By more accurately predicting future resource usage (e.g., based on the more detailed or granular information gleaned from the user interactions), resource utilization and adjustment may be improved.

In some examples, the techniques described herein may result in improved precision in resource scaling. This promotes correct allocation of resources based on actual usage patterns, reducing waste, improving performance, and reducing costs. In some examples, the techniques described herein may result in improved flexibility, as administrators can define scaling conditions in natural language, simplifying the management process. In some examples, the techniques described herein may result in improved intelligent decision making, as AI-driven insights may provide a deeper understanding of usage patterns, leading to more effective scaling decisions. In some examples, the techniques described herein may result in improved cost efficiency. By optimizing resource allocation based on precise usage patterns, the system minimizes over-provisioning and under-provisioning, leading to significant cost savings. In some examples, the techniques described herein may result in improved performance, as automatic scaling supports web services that can handle varying loads efficiently, maintaining high performance and reliability even during peak usage. In some examples, the techniques described herein may result in improved real-time (or reduced latency) adaptation, as the system may update its training data and scaling decisions in real-time, allowing for immediate or quicker adaptation to changing usage patterns. In some examples, the techniques described herein may result in improved (e.g., reduced) administrative overhead, as the use of natural language processing (NLP) for setting conditions simplifies the administrative burden, allowing non-technical staff to manage scaling policies, rules, parameters, or operations. In some examples, the techniques described herein may result in improved scalability, as the system itself can scale to manage large and complex web applications with numerous views and APIs, making it suitable for enterprise-level deployments. In some examples, the techniques described herein may result in improved security integration, as utilizing the level 7 (L7) web application firewall) WAF bot not only facilitates data collection but also enhances security by integrating with existing web application firewall functionalities. In some examples, the techniques described herein may result in improved predictive scaling. By analyzing historical data and usage trends, a system can predict future scaling needs and proactively adjust resources, preventing or reducing performance bottlenecks. In some examples, the techniques described herein may result in improved user experience, as prompting improved performance and availability of web services enhances the overall user experience, leading to higher user satisfaction and retention. In some examples, the techniques described herein may result in improved (e.g., more customizable) policies, as administrators can create highly customized scaling policies tailored to specific business considerations, providing granular control over resource allocation in natural language format, without any standard formats. In some examples, the techniques described herein may result in improved interoperability, as the system can be integrated with various cloud platforms and infrastructure providers, offering flexibility in deployment and management. In some examples, the techniques described herein may result in improved (e.g., more robust) data insights, as the graph database structure provides a rich source of insights into user behavior and system performance, which can be leveraged for further optimization and business intelligence.

In some examples, users may interact with web service elements. In some examples, web service elements may include one or more web views or may themselves be web views. In some examples, web service elements are also referred to as web views. In any case, such web service elements or web views may invoke one or more API calls that perform operations. This information may be monitored and compiled into graph databases and corresponding mappings between the web views and APIs may be generated. The user may further provide natural language input to the system which may indicate one or more rules or operations to be implemented for resource allocation, adjustment, and processing. The system may process the natural language input (e.g., using a generative AI model or other processing) to determine or extract the rules or instructions and may accordingly adjust one or more resource allocation parameters (e.g., in accordance with the rules or instructions). It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

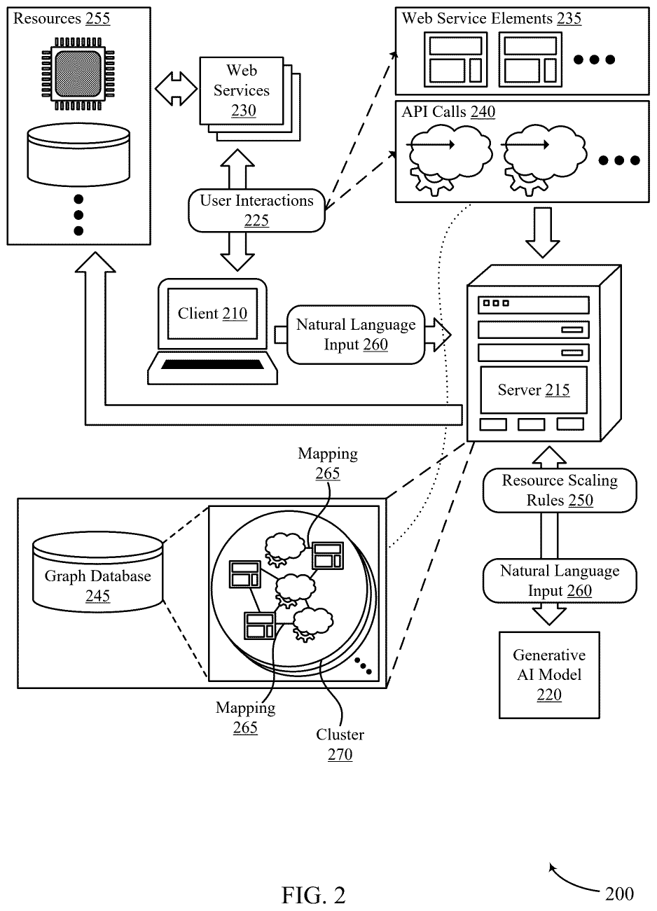

FIG. 2 illustrates an example of processing system 200 that supports web service resource scaling in accordance with aspects of the present disclosure, techniques for processing queries related to network security in accordance with aspects of the present disclosure. The processing system 200 may include a client 210, a server 215, and a generative AI model 220. The server 215 may represent a single server or processing entity, multiple servers or processing entities, a complete processing system, or any other entity capable of performing the operations described herein. The generative AI model 220 may be included as part of or otherwise associated with the server 215 or may operate independently of the server 215.

In some examples, the server 215 may monitor (e.g., via one or more monitoring agents at the client 210, the web services 230, one or more other locations, or any combination thereof) the user interactions 225 with the web services 230. The server 215 may, based on these user interactions 225, identify one or more web service elements 235, one or more API calls 240, one or more other interactions, or any combination thereof, that are associated with the use of the web services 230 by the user (e.g., via the client 210).

In some examples, the server may generate (e.g., based on a machine learning analysis, such as an analysis using the generative AI model 220) of the first plurality of user interactions, a graph database 245. The graph database 245 may include mappings 265 between the web service elements 235, the plurality of API calls 240, one or more other elements, interactions, or information, or any combination thereof. In some examples, the mappings 265 may be organized into user-based clusters 270 (e.g., the mappings for a user or a group of users may be joined together into one or more clusters 270).

In some examples, the server 215 may receive the natural language input 260, which may include one or more instructions, directions, rules, guidelines, thresholds, triggering conditions, parameters, information, or any combination thereof, for scaling the resources 255. The resources 255 may be resources used to provide one or more of the web services 230 with which the user interacts via the client 210. These resources 255 may include any resources that may support the web services 230, including compute resources, memory resources, processing resources, storage resources, communication resources or bandwidth, power resources, one or more other resources, or any combination thereof.

In some examples, the system 200 may process the natural language input 260 (e.g., using the generative AI model 220, natural language processing techniques, named entity recognition, one or more other processing models or techniques, or any combination thereof), to identify one or more resource scaling rules 250 from the natural language input 260. The server 215 may, as a result, adjust one or more resource allocation parameters that adjust the usage of the resources 255 for the web services 230. The server 215 may do so based on any elements of or information associated with the system 200, including the webst service elements 235, the API calls 240, the graph database 245, the clusters 270, the mapping, the user interactions 225, the resource scaling rules 250, one or more other elements or information, characteristics of any of the preceding elements or information, or any combination thereof.

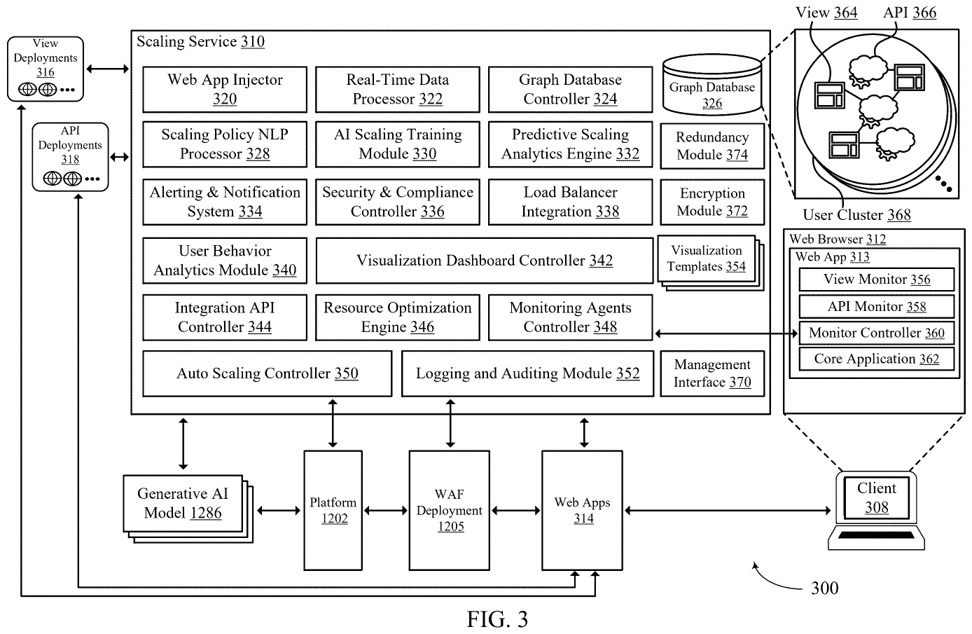

FIG. 3 shows an example of a resource scaling system 300 that supports web service resource scaling in accordance with aspects of the present disclosure. The resource scaling system 300 may involve the scaling service 310. Further, the resource scaling system 300 may involve the platform 1202 and the WAF deployment 1205.

The system 300 may include a platform 1202, which may orchestrate the coordination and management of distributed denial of service (DDoS) protection solutions (e.g., WAFs included in the WAF deployment 1205) or other protection schemes deployed across diverse substrates. The system 300 may include automated incident detection and mitigation capabilities, utilizing real-time traffic analysis and anomaly detection algorithms. The system 300 may include alerts from the WAFs capturing of and analysis of data related to security events. The system 300 may include configurable alerting mechanisms to notify users or administrators of potential attacks, enabling timely response and mitigation actions. The system 300 may include dynamic signature management functionalities (e.g., determining characteristics of DDoS events) for adapting to evolving attack vectors and patterns. For example, DDoS events may have signatures, characteristics, or patterns to them, including pinging, logins, website crawling, and others. The system 300 may detect such signatures, characteristics, or patterns, and dynamically generate configurations based at least in part on such signatures, characteristics, or patterns. The system 300 may include query resolution modules enabling automated responses to inquiries related to DDoS incidents, configurations, and mitigation strategies. In some examples, configuration-related operations associated with the platform 1202 may persist (e.g., using JavaScript Object Notation (JSON) non structured query language (NoSQL) databases or in other formats). Further, in some examples, non-confidential configurations may be stored in version control repositories, facilitating external tracking of changes with ease, including history.

In some examples, the WAF deployment 1205 may include one or more WAFs deployed to protect a computing system. The WAFs (also referred to as web application firewalls) may be third-party services that perform operations to detect and mitigate DDoS attacks or other attacks on a system. Different WAFs may be better suited to different operations, different types of DDoS (or other) attacks, and the system 300 may dynamically generate configurations for these different WAFs based on such characteristics of the WAFs.

As described herein, other web applications may face significant challenges in managing the scaling of views hosted on web page servers and APIs (e.g., on REST servers). For example, other auto-scaling mechanisms often lack the precision needed to optimally allocate resources based on actual usage patterns of both views and APIs. Also, the conditions that can be configured for scaling may be static and limited to standard format. Such inefficiencies can lead to either over-provisioning, which wastes resources and increases costs, or under-provisioning, which degrades performance.

The resource scaling system 300 may reduce or eliminate such challenges and improve performance, costs, resource provisioning, and overall operation of web services. For example, the resource scaling system 300 may provide at least a portion of an AI-driven system for the improved automatic scaling of web apps 314 (e.g., resources that support such web apps 314) by generating and utilizing optimal training data that correlates web service views and API usage. In some examples, an L7 WAF bot or the web app injector 320 (which may be an example of an L7 WAF bot) may inject monitoring agents (e.g., one or more instances of the view monitor 356, the API monitor 358, or any combination thereof) into web apps 314, such as the web app 313, to collect user interaction data specific to views and APIs, which is structured in a graph database 326 and fed into AI systems for training. In some examples, the monitoring agents may be controlled by or communicate with the monitoring agents controller 348, which may manage one or more aspects of operation of the monitoring agents. For example, the monitoring agents controller 348 may provide instructions or updates to the monitoring agents. Additionally, or alternatively, the monitoring agents controller 348 may receive the data collected or generated by the monitoring agents, which may be passed to one or more other elements of the resource scaling system 300 for storage or further processing (e.g., as described herein). In some examples, the monitor controller 360 may act as an interface between the monitoring agents controller 348 and the individual monitoring agents (e.g., one or more instances of the view monitor 356, the API monitor 358, or any combination thereof).

The collected data may be analyzed by AI systems (e.g., the generative AI model 1286) and administrators can set scaling conditions in natural language. The AI system interprets these conditions and dynamically adjusts resource allocation to promote improved performance and resource utilization with the help of load balancer integration and the integration of the user clusters 368 of views 364 and APIs 366 in the graph database 326 (which may be managed or controlled by the graph database controller 324). In some examples, the techniques described herein may be implemented, partially or completely, in one or more L7 WAF bots (e.g., which may be included in or associated with the WAF deployment 1205), which are described elsewhere herein.

The resource scaling system 300 may include the scaling service 310. The scaling service may include or be associated with various elements that may perform various portions of operations associated with resource scaling. The scaling service 310 or one or more of the elements thereof, may communicate with the web apps 314, the view deployments 316, the API deployments 318, the platform 1202, the WAF deployment 1205, or any combination thereof, to perform or support one or more operations described herein. It should be noted that any of the elements described herein may employ the generative AI model 1286 or other processing models or elements to perform at least a portion of the operations described herein.

In some examples, a L7 WAF extension may be employed (e.g., as part of or in association with the WAF deployment 1205). The web app injector 320 may be an example of such an extension. The L7 WAF extension may be a security layer extension that may include one or more bots capable of injecting monitoring agents into the web apps 314 to observe user interactions. In some examples, the embedded monitoring agents may track the user interactions with views 364 and API calls (e.g., associated with the APIs 366), collecting detailed usage data.

In some examples, the graph database 326 may store the collected data in a format that captures the relationships between the views 364 and usage of the APIs 366 (e.g., though API calls) enabling efficient querying and analysis. In some examples, the graph database 326 may be managed or controlled by the graph database controller 324. In some examples, the generative AI model 1286, the AI scaling training module 330, or both, may analyzes the graph database to identify patterns and correlations between the web service views 364 and API calls, utilizing machine learning algorithms. In some examples, the scaling policy NLP processor 328 may translate administrator-defined conditions, (e.g., referred to in some cases as one or more policies), into actionable instructions for the AI system, allowing for easy policy setting.

In some examples, the auto scaling controller 350 may execute one or more scaling actions based on AI-driven insights (e.g., results of processing natural language input via the generative AI model 1286 or other element), administrator conditions, policies, or other information, dynamically adjusting resource allocation. In some examples, the real-time data processor 322 may processes incoming data (e.g., continually, periodically, or on demand) from the monitoring agents (e.g., one or more instances of the view monitor 356, the API monitor 358, or any combination thereof) and update the graph database 326 in real-time (e.g., continually, periodically, or on demand) to include current information for the processing described herein.

In some examples, the predictive scaling analytics engine 332 may employ historical data and machine learning models to predict future usage patterns and proactively adjust resource allocation to prevent performance issues. In some examples, a management interface 370 may provide administrators with a user-friendly interface to define scaling policies, view system status, and manage the overall configuration. For example, an administrator may provide input to configure any of the elements of the resource scaling system 300, including those elements of the scaling service 310.

In some examples, the resource scaling system 300 may include an API gateway that may manages API requests and provides an additional layer of control over API traffic, enabling more precise monitoring and management of API usage. In some examples, the load balancer integration 338 may interfaces with load balancers (e.g., based on one or more policies or instructions from administrators, operations taken as a result of determining policies or instructions from the natural language input, or any other operation or information described herein) to distribute traffic effectively based on usage patterns and AI-driven recommendations. In some examples, the alerting and notification system 334 may notify administrators of significant events, such as scaling actions or potential issues, through various channels (e.g., email, SMS, dashboards, or any other means of communication).

In some examples, the logging and auditing module 352 may keep detailed logs of all scaling actions, system changes, and user interactions for auditing, compliance, and troubleshooting purposes. In some examples, the logging and auditing module 352 may coordinate or communicate with the WAF deployment 1205 to keep or update such logs. In some examples, the security and compliance manager 336 may monitor the system 300 for compliance with relevant security standards and regulations (e.g., as provided or indicated by an administrator), providing additional security measures and controls. For example, an administrator may make one or more adjustments to the security measures, controls, policies, or other aspects of the security and compliance manager 336.

In some examples, the system 300 may include one or more redundancy and failover mechanisms (e.g., via the redundancy module 374) that may promote high availability and reliability by incorporating redundancy and failover capabilities, allowing the system to handle failures gracefully. For example, any of the elements may be supported by the redundancy and failover mechanisms that may take over the responsibilities, assignments, operations, information, or other aspects of operation of the elements in the case that the elements fail or are operating improperly.

In some examples, the resource optimization engine 346 may continuously (additionally, or alternatively, on a periodic, semi-periodic, or on-demand basis) analyze resource usage and identify opportunities for optimization, recommending adjustments to improve efficiency (e.g., through the use of the generative AI model 1286).

In some examples, the visualization dashboard controller 342 may provide visual representations of usage patterns, scaling actions, and system performance metrics, aiding in decision-making and monitoring. In some examples, the visualization dashboard controller 342 may utilize one or more visualization templates 354 as a basis for generating the visualizations. In some examples, an administrator may provide or modify one or more visualization templates 354. In some examples, the user behavior analytics module 340 may analyzes user behavior (e.g., in connection with a generative AI model 1286), to identify trends and anomalies, contributing to more accurate scaling decisions and improved user experience. In some examples, the integration API controller 344 may allow the system to integrate with various third-party tools and platforms, enhancing its functionality and flexibility. For example, any of the elements described herein may perform at least a portion of any of the operations described herein by interfacing with the integration API controller 344 to communicate with one or more APIs and perform the operations described herein. In some examples, an encryption module 372 that may encrypt or decrypt information used to perform one or more operations described herein, to promote data security both in transit and at rest, maintaining data privacy and integrity.

In some examples, the resource scaling system 300 may perform one or more operations for data collection. For example, the monitoring agents (e.g., one or more instances of the view monitor 356, the API monitor 358, or any combination thereof) within the web app 313 may track user interactions with views 364 and corresponding calls to the APIs 366, such as those performed in connection with the core application 362, which may represent one or more applications providing services to the user at the client 308 through the web app 313 and the web browser 312. In some examples, this may be performed using document object model (DOM) scanning and API object overriding (e.g., like XMLHttpRequest). The collected data may be transmitted to the real time data processor 322, which may update the scalable graph database 326 (e.g., which may be deployed in a public cloud, a private cloud, a local database, or other storage location), which may be associated with L7 WAF operations, such as the WAF deployment 1205.

In some examples, the resource scaling system 300 may perform one or more operations for data storage. For example, the graph database 326 may store the collected data in a format that captures the relationships between the views 364 and the APIs 366 (e.g., or API calls to such APIs 366), such as a graph database format or other format. In some examples, the relationships, mappings, or other information associated with the views 364 and the APIs 366 may be collected in clusters on a per-user basis (or on another basis, such as a usage domain basis, an API basis, a web domain basis, or any other organization or basis). Such information may be processed by one or more AI models (e.g., the generative AI model 1286) as described herein. Such storage techniques may promote efficient querying and analysis of the data stored in the graph database 326. By consolidating such information and allowing such querying and analysis of the information, improved resource scaling and allocation policies may be generated and deployed, resulting in improved resource scaling and allocation.

In some examples, the resource scaling system 300 may perform one or more operations for AI training. For example, the AI scaling training module 330 may process the data from the graph database 326 to identify patterns and correlations between web service views 364 and API 366 calls using machine learning algorithms. Further the AI scaling training module 330 may train the generative AI model 1286 or other models to improve the capabilities of the models to detect such patterns and correlations. In some examples, the predictive scaling analytics engine 332 may analyze historical data and machine learning models to forecast future usage patterns.

In some examples, the resource scaling system 300 may perform one or more operations for condition specification, policy formation or modification, or rule-setting operations. For example, an administrator may use the management interface 370 to input scaling conditions in natural language. Examples of such natural language input may be as follows: “If a view is used by more than 500K customers with minimal 100K highest used APIs calls involved, scale up” or “If a specific API is underutilized for 5 days with a majority of used views along with 10K usage in least used views, scale down.” In some examples, the resource scaling system 300 may perform one or more operations for NLP interpretation. For example, the scaling policy NLP processor 328 (additionally, or alternatively, the generative AI model 1286), may translate these conditions into actionable instructions that the AI system can understand and act upon.

In some examples, the resource scaling system 300 may perform one or more operations for executing resource scaling, resource allocation, or resource assignment. For example, the auto-scaling controller 350 may dynamically adjust the resources allocated to web page servers and API or REST servers based on AI-driven insights (e.g., as determined through the use of the scaling policy NLP processor 328 or the 1286) and administrator-defined conditions (e.g., as received or modified through the management interface 370). In some examples, the load balancer integration 338 balances traffic based on usage patterns and AI recommendations (e.g., as determined through the use of the scaling policy NLP processor 328 or the 1286).

In some examples, the resource scaling system 300 may perform one or more operations for adaptation operations. For example the real-time data processor 322 may process incoming data from the monitoring agents (e.g., one or more instances of the view monitor 356, the API monitor 358, or both), providing current information for accurate scaling decisions. Additionally, or alternatively, the predictive scaling analytics engine 332 may proactively adjust resource allocation based on forecasted usage patterns (e.g., determined using the generative AI model 1286 or other elements of the resource scaling system 300) to prevent or reduce performance issues.

In some examples, the resource scaling system 300 may perform one or more operations for monitoring and notification. For example, the alerting and notification system 334 may notify administrators of significant events, such as scaling actions or potential issues, through various channels (e.g., email, SMS, dashboards).

In some examples, the resource scaling system 300 may perform one or more operations for security and compliance. For example, the security and compliance manager 336 performs operations to promote compliance with relevant security standards and regulations (e.g., as defined or modified through the management interface 370), providing additional security measures and controls, so that customer privacy is always maintained as per standards. Additionally, or alternatively, the encryption module 372 secures all collected data both in transit and at rest, maintaining data privacy and integrity.

In some examples, the resource scaling system 300 may perform one or more operations for logging and auditing. For example, the logging and auditing module 352 may keep detailed logs of scaling actions, system changes, and user interactions for auditing, compliance, and troubleshooting purposes. In some examples, the resource scaling system 300 may perform one or more operations for resource optimization. For example, the 346 may analyze resource usage, identifying opportunities for optimization and recommending adjustments to improve efficiency. Such opportunities or information associated therewith may be transmitted to the auto scaling controller 350 or other element of the resource scaling system 300, so that one or more corresponding resource scaling or allocation operations may be carried out.

In some examples, the resource scaling system 300 may perform one or more operations for visualization and reporting. For example, the visualization dashboard controller 342 may provide visual representations of usage patterns, scaling actions, and system performance metrics, aiding in decision-making and monitoring. Additionally, or alternatively, the user behavior analytics module 340 may analyze user behavior to identify trends and anomalies, contributing to more accurate scaling decisions and improved user experience.

In some examples, the resource scaling system 300 may perform one or more operations for integration and interoperability. For example, the integration API controller 344 may allow the system to connect with various third-party tools and platforms, enhancing its functionality and flexibility. Additionally, or alternatively, the redundancy module 374 may manage one or more redundancy and failover capabilities or operations, allowing the system to handle failures or one or more elements of the resource scaling system 300 by providing additional resources or resource assignments to perform the operations previously performed by the failing elements.

FIG. 19 shows an example of a process flow 400 that supports web service resource scaling in accordance with aspects of the present disclosure. The process flow 400 may implement various aspects of the present disclosure described herein. For example, the process flow 400 may describe operations associated with resource scaling or allocation and inputs or control thereof. The elements described in the process flow 400 (e.g., application server 415, client 405, and web services 410) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the application server 415 may embed, with a WAF application associated with the plurality of web services 410, a plurality of monitoring agents in the plurality of web services 410.

At 422, the application server 415 may monitor a first plurality of user interactions with a plurality of web services 410 (e.g., between the client 405 and the web services 410) to identify a plurality of web service elements and a plurality of API calls associated with the plurality of web service elements. In some examples, the monitoring of the first plurality of user interactions is performed using the plurality of monitoring agents.

At 424, the application server 415 may train a generative AI model based on training data that may include web service element patterns and API call patterns.

At 426, the application server 415 may generate, based on a machine learning analysis of the first plurality of user interactions, a graph database that may include a plurality of mappings between the plurality of web service elements and the plurality of API calls, the plurality of mappings organized into user-based clusters. In some examples, the machine learning analysis is performed with the trained generative AI model. In some examples, the plurality of mappings is based on one or more recognized patterns in the first plurality of user interactions.

At 428, the application server 415 may update the graph database based on a second machine learning analysis of a second plurality of user interactions with the plurality of web services 410.

At 430, the application server 415 may update the training data based on the graph database.

At 432, the application server 415 may generate, using a generative AI model and based on the graph database, one or more predicted service element patterns, one or more predicted API call patterns, or any combination thereof that are associated with the plurality of web services 410.

At 434, the application server 415 may receive natural language input that includes one or more instructions for scaling resources associated with the plurality of web services 410 from administrators.

At 436, the application server 415 may process the natural language input to identify one or more resource scaling rules from the one or more instructions.

At 438, the application server 415 may adjust one or more resource allocation parameters for the plurality of web services 410 based on the plurality of mappings and the identified one or more resource scaling rules. In some examples, the one or more resource allocation parameters may be adjusted based on the one or more recognized patterns. In some examples, the adjustment of the one or more resource allocation parameters for the plurality of web services 410 is based on the one or more predicted service element patterns, the one or more predicted API call patterns, or any combination thereof.

At 440, the application server 415 may adjust one or more load balancing parameters for the plurality of web services 410 based on the plurality of mappings and one or more one or more resources scaling rules.

At 442, the application server 415 may transmit one or more alerts based on the one or more resource allocation parameters satisfying one or more resource allocation thresholds.

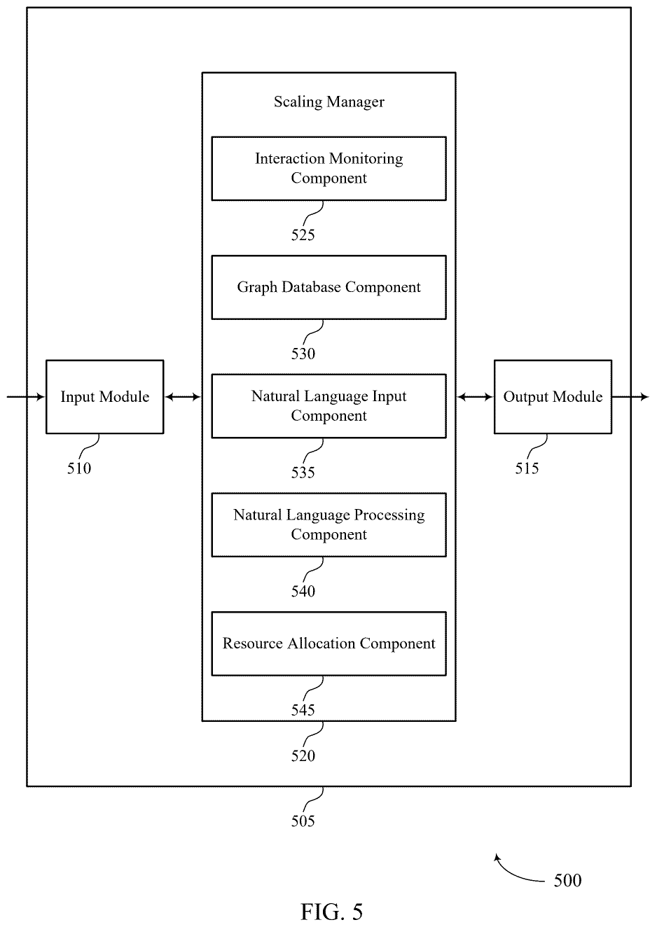

FIG. 5 shows a block diagram 500 of a device 505 that supports web service resource scaling in accordance with aspects of the present disclosure. The device 505 may include an input module 510, an output module 515, and a scaling manager 520. The device 505, or one of more components of the device 505 (e.g., the input module 510, the output module 515, the scaling manager 520), may include at least one processor, which may be coupled with at least one memory, to support the described techniques. Each of these components may be in communication with one another (e.g., via one or more buses).

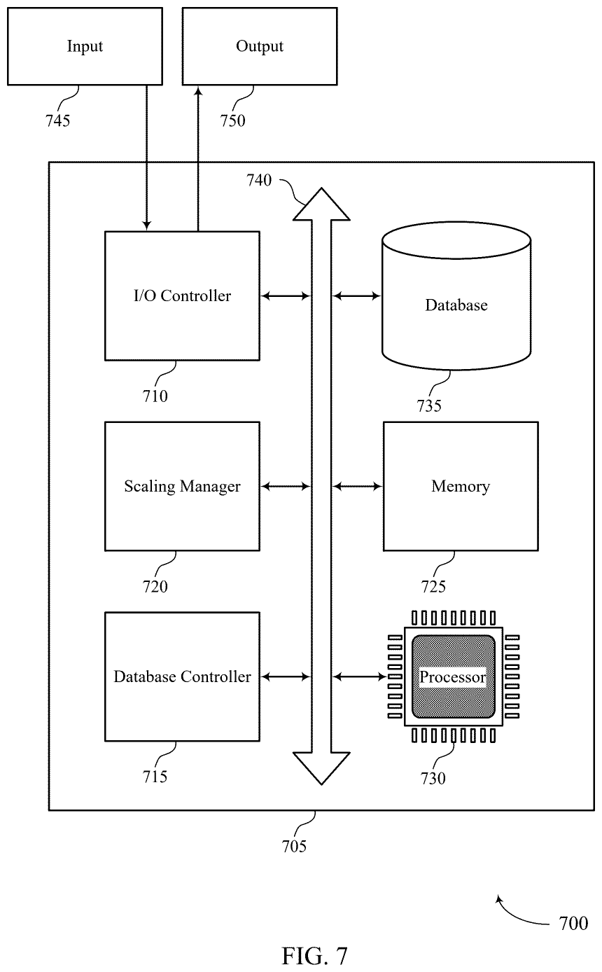

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the scaling manager 520 to support web service resource scaling. In some cases, the input module 510 may be a component of an input/output (I/O) controller 710 as described with reference to FIG. 7.

The output module 515 may manage output signals for the device 505. For example, the output module 515 may receive signals from other components of the device 505, such as the scaling manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the scaling manager 520 may include an interaction monitoring component 525, a graph database component 530, a natural language input component 535, a natural language processing component 540, a resource allocation component 545, or any combination thereof. In some examples, the scaling manager 520, or various components thereof, may be configured to perform various operations (e.g., receiving, monitoring, transmitting) using or otherwise in cooperation with the input module 510, the output module 515, or both. For example, the scaling manager 520 may receive information from the input module 510, send information to the output module 515, or be integrated in combination with the input module 510, the output module 515, or both to receive information, transmit information, or perform various other operations as described herein.

The scaling manager 520 may support resource scaling in accordance with examples as disclosed herein. The interaction monitoring component 525 may be configured to support monitoring a first set of multiple user interactions with a set of multiple web services to identify a set of multiple web service elements and a set of multiple API calls associated with the set of multiple web service elements. The graph database component 530 may be configured to support generating, based on a machine learning analysis of the first set of multiple user interactions, a graph database that includes a set of multiple mappings between the set of multiple web service elements and the set of multiple API calls, the set of multiple mappings organized into user-based clusters. The natural language input component 535 may be configured to support receiving natural language input that includes one or more instructions for scaling resources associated with the set of multiple web services. The natural language processing component 540 may be configured to support processing the natural language input to identify one or more resource scaling rules from the one or more instructions. The resource allocation component 545 may be configured to support adjusting one or more resource allocation parameters for the set of multiple web services based on the set of multiple mappings and the identified one or more resource scaling rules.

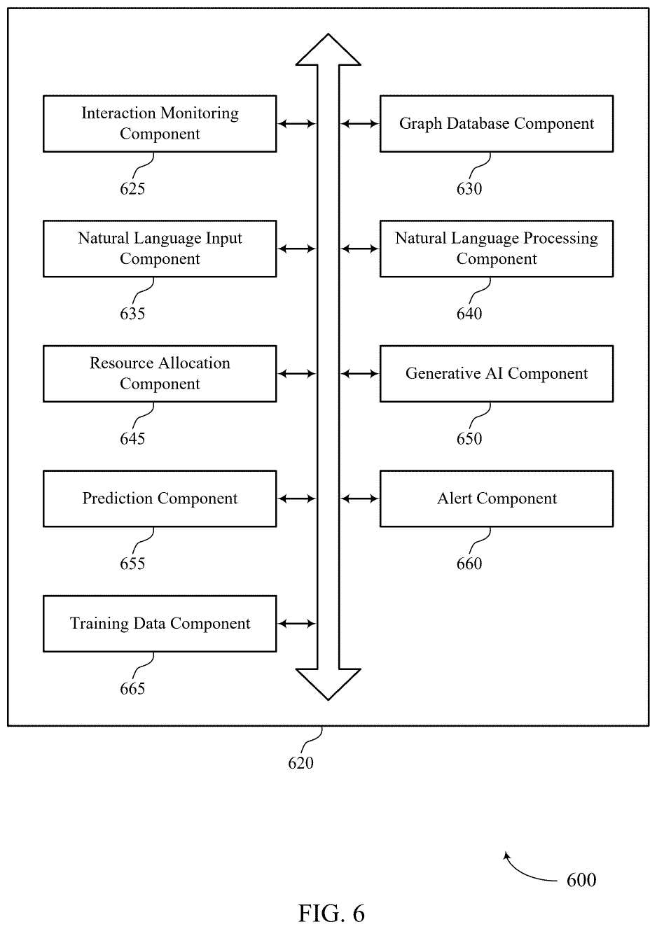

FIG. 6 shows a block diagram 600 of a scaling manager 620 that supports web service resource scaling in accordance with aspects of the present disclosure. The scaling manager 620 may be an example of aspects of a scaling manager or a scaling manager 520, or both, as described herein. The scaling manager 620, or various components thereof, may be an example of means for performing various aspects of web service resource scaling as described herein. For example, the scaling manager 620 may include an interaction monitoring component 625, a graph database component 630, a natural language input component 635, a natural language processing component 640, a resource allocation component 645, a generative AI component 650, a prediction component 655, an alert component 660, a training data component 665, or any combination thereof. Each of these components, or components of subcomponents thereof (e.g., one or more processors, one or more memories), may communicate, directly or indirectly, with one another (e.g., via one or more buses).

The scaling manager 620 may support resource scaling in accordance with examples as disclosed herein. The interaction monitoring component 625 may be configured to support monitoring a first set of multiple user interactions with a set of multiple web services to identify a set of multiple web service elements and a set of multiple API calls associated with the set of multiple web service elements. The graph database component 630 may be configured to support generating, based on a machine learning analysis of the first set of multiple user interactions, a graph database that includes a set of multiple mappings between the set of multiple web service elements and the set of multiple API calls, the set of multiple mappings organized into user-based clusters. The natural language input component 635 may be configured to support receiving natural language input that includes one or more instructions for scaling resources associated with the set of multiple web services. The natural language processing component 640 may be configured to support processing the natural language input to identify one or more resource scaling rules from the one or more instructions. The resource allocation component 645 may be configured to support adjusting one or more resource allocation parameters for the set of multiple web services based on the set of multiple mappings and the identified one or more resource scaling rules.

In some examples, the generative AI component 650 may be configured to support training a generative AI model based on training data that includes web service element patterns and API call patterns. In some examples, the graph database component 630 may be configured to support where the machine learning analysis is performed with the trained generative AI model. In some examples, the graph database component 630 may be configured to support where the set of multiple mappings are based on one or more recognized patterns in the first set of multiple user interactions.

In some examples, the resource allocation component 645 may be configured to support adjusting the one or more resource allocation parameters based on the one or more recognized patterns.

In some examples, the training data component 665 may be configured to support updating the training data based on the graph database.

In some examples, the prediction component 655 may be configured to support generating, using a generative AI model and based on the graph database, one or more predicted service element patterns, one or more predicted API call patterns, or any combination thereof that are associated with the set of multiple web services. In some examples, the resource allocation component 645 may be configured to support where adjusting the one or more resource allocation parameters for the set of multiple web services is based on the one or more predicted service element patterns, the one or more predicted API call patterns, or any combination thereof.

In some examples, the interaction monitoring component 625 may be configured to support embedding, with a web application firewall application associated with the set of multiple web services, a set of multiple monitoring agents in the set of multiple web services. In some examples, the interaction monitoring component 625 may be configured to support where monitoring the first set of multiple user interactions is performed using the set of multiple monitoring agents.

In some examples, the graph database component 630 may be configured to support updating the graph database based on a second machine learning analysis of a second set of multiple user interactions with the set of multiple web services.

In some examples, the resource allocation component 645 may be configured to support adjusting one or more load balancing parameters for the set of multiple web services based on the set of multiple mappings and one or more one or more resources scaling rules.

In some examples, the alert component 660 may be configured to support transmitting one or more alerts based on the one or more resource allocation parameters satisfying one or more resource allocation thresholds.

FIG. 7 shows a diagram of a system 700 including a device 705 that supports web service resource scaling in accordance with aspects of the present disclosure. The device 705 may be an example of or include components of a device 505 as described herein. The device 705 may include components for bi-directional data communications including components for transmitting and receiving communications, such as a scaling manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting web service resource scaling). The processor 730 may be an example of a single processor or multiple processors. For example, the device 705 may include one or more processors 730.

The scaling manager 720 may support resource scaling in accordance with examples as disclosed herein. For example, the scaling manager 720 may be configured to support monitoring a first set of multiple user interactions with a set of multiple web services to identify a set of multiple web service elements and a set of multiple API calls associated with the set of multiple web service elements. The scaling manager 720 may be configured to support generating, based on a machine learning analysis of the first set of multiple user interactions, a graph database that includes a set of multiple mappings between the set of multiple web service elements and the set of multiple API calls, the set of multiple mappings organized into user-based clusters. The scaling manager 720 may be configured to support receiving natural language input that includes one or more instructions for scaling resources associated with the set of multiple web services. The scaling manager 720 may be configured to support processing the natural language input to identify one or more resource scaling rules from the one or more instructions. The scaling manager 720 may be configured to support adjusting one or more resource allocation parameters for the set of multiple web services based on the set of multiple mappings and the identified one or more resource scaling rules.

By including or configuring the scaling manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

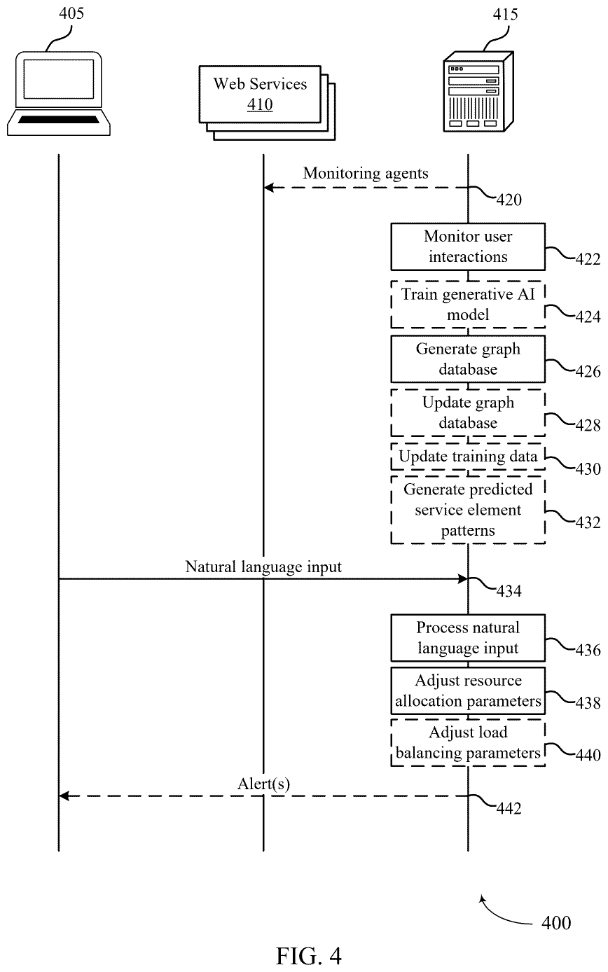

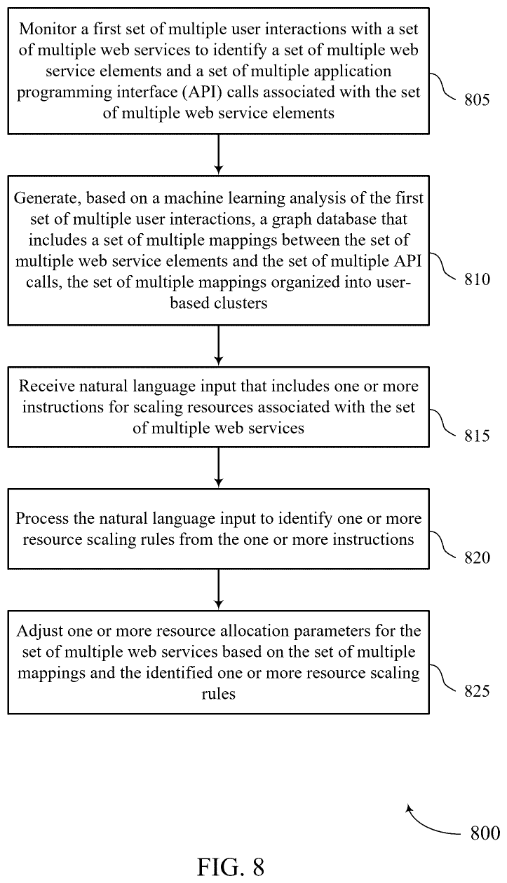

FIG. 8 shows a flowchart illustrating a method 800 that supports web service resource scaling in accordance with aspects of the present disclosure. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include monitoring a first set of multiple user interactions with a set of multiple web services to identify a set of multiple web service elements and a set of multiple API calls associated with the set of multiple web service elements. The operations of 805 may be performed in accordance with examples as disclosed herein. In some examples, aspects of the operations of 805 may be performed by an interaction monitoring component 525 as described with reference to FIG. 5.

At 810, the method may include generating, based on a machine learning analysis of the first set of multiple user interactions, a graph database that includes a set of multiple mappings between the set of multiple web service elements and the set of multiple API calls, the set of multiple mappings organized into user-based clusters. The operations of 810 may be performed in accordance with examples as disclosed herein. In some examples, aspects of the operations of 810 may be performed by a graph database component 530 as described with reference to FIG. 5.

At 815, the method may include receiving natural language input that includes one or more instructions for scaling resources associated with the set of multiple web services. The operations of 815 may be performed in accordance with examples as disclosed herein. In some examples, aspects of the operations of 815 may be performed by a natural language input component 535 as described with reference to FIG. 5.

At 820, the method may include processing the natural language input to identify one or more resource scaling rules from the one or more instructions. The operations of 820 may be performed in accordance with examples as disclosed herein. In some examples, aspects of the operations of 820 may be performed by a natural language processing component 540 as described with reference to FIG. 5.

At 825, the method may include adjusting one or more resource allocation parameters for the set of multiple web services based on the set of multiple mappings and the identified one or more resource scaling rules. The operations of 825 may be performed in accordance with examples as disclosed herein. In some examples, aspects of the operations of 825 may be performed by a resource allocation component 545 as described with reference to FIG. 5.

A method for resource scaling by an application server is described. The method may include monitoring a first set of multiple user interactions with a set of multiple web services to identify a set of multiple web service elements and a set of multiple API calls associated with the set of multiple web service elements, generating, based on a machine learning analysis of the first set of multiple user interactions, a graph database that includes a set of multiple mappings between the set of multiple web service elements and the set of multiple API calls, the set of multiple mappings organized into user-based clusters, receiving natural language input that includes one or more instructions for scaling resources associated with the set of multiple web services, processing the natural language input to identify one or more resource scaling rules from the one or more instructions, and adjusting one or more resource allocation parameters for the set of multiple web services based on the set of multiple mappings and the identified one or more resource scaling rules.

An application server for resource scaling is described. The application server may include one or more memories storing processor executable code, and one or more processors coupled with the one or more memories. The one or more processors may individually or collectively be operable to execute the code to cause the application server to monitor a first set of multiple user interactions with a set of multiple web services to identify a set of multiple web service elements and a set of multiple API calls associated with the set of multiple web service elements, generate, based on a machine learning analysis of the first set of multiple user interactions, a graph database that includes a set of multiple mappings between the set of multiple web service elements and the set of multiple API calls, the set of multiple mappings organized into user-based clusters, receive natural language input that includes one or more instructions for scaling resources associated with the set of multiple web services, process the natural language input to identify one or more resource scaling rules from the one or more instructions, and adjust one or more resource allocation parameters for the set of multiple web services based on the set of multiple mappings and the identified one or more resource scaling rules.

Another application server for resource scaling is described. The application server may include means for monitoring a first set of multiple user interactions with a set of multiple web services to identify a set of multiple web service elements and a set of multiple API calls associated with the set of multiple web service elements, means for generating, based on a machine learning analysis of the first set of multiple user interactions, a graph database that includes a set of multiple mappings between the set of multiple web service elements and the set of multiple API calls, the set of multiple mappings organized into user-based clusters, means for receiving natural language input that includes one or more instructions for scaling resources associated with the set of multiple web services, means for processing the natural language input to identify one or more resource scaling rules from the one or more instructions, and means for adjusting one or more resource allocation parameters for the set of multiple web services based on the set of multiple mappings and the identified one or more resource scaling rules.

A non-transitory computer-readable medium storing code for resource scaling is described. The code may include instructions executable by one or more processors to monitor a first set of multiple user interactions with a set of multiple web services to identify a set of multiple web service elements and a set of multiple API calls associated with the set of multiple web service elements, generate, based on a machine learning analysis of the first set of multiple user interactions, a graph database that includes a set of multiple mappings between the set of multiple web service elements and the set of multiple API calls, the set of multiple mappings organized into user-based clusters, receive natural language input that includes one or more instructions for scaling resources associated with the set of multiple web services, process the natural language input to identify one or more resource scaling rules from the one or more instructions, and adjust one or more resource allocation parameters for the set of multiple web services based on the set of multiple mappings and the identified one or more resource scaling rules.

Some examples of the method, application servers, and non-transitory computer-readable medium described herein may further include operations, features, means, or instructions for training a generative AI model based on training data that includes web service element patterns and API call patterns, where the machine learning analysis may be performed with the trained generative AI model, and where the set of multiple mappings may be based on one or more recognized patterns in the first set of multiple user interactions.

Some examples of the method, application servers, and non-transitory computer-readable medium described herein may further include operations, features, means, or instructions for adjusting the one or more resource allocation parameters based on the one or more recognized patterns.

Some examples of the method, application servers, and non-transitory computer-readable medium described herein may further include operations, features, means, or instructions for updating the training data based on the graph database.

Some examples of the method, application servers, and non-transitory computer-readable medium described herein may further include operations, features, means, or instructions for generating, using a generative AI model and based on the graph database, one or more predicted service element patterns, one or more predicted API call patterns, or any combination thereof that may be associated with the set of multiple web services and where adjusting the one or more resource allocation parameters for the set of multiple web services may be based on the one or more predicted service element patterns, the one or more predicted API call patterns, or any combination thereof.

Some examples of the method, application servers, and non-transitory computer-readable medium described herein may further include operations, features, means, or instructions for embedding, with a web application firewall application associated with the set of multiple web services, a set of multiple monitoring agents in the set of multiple web services and where monitoring the first set of multiple user interactions may be performed using the set of multiple monitoring agents.

Some examples of the method, application servers, and non-transitory computer-readable medium described herein may further include operations, features, means, or instructions for updating the graph database based on a second machine learning analysis of a second set of multiple user interactions with the set of multiple web services.

Some examples of the method, application servers, and non-transitory computer-readable medium described herein may further include operations, features, means, or instructions for adjusting one or more load balancing parameters for the set of multiple web services based on the set of multiple mappings and one or more one or more resources scaling rules.

Some examples of the method, application servers, and non-transitory computer-readable medium described herein may further include operations, features, means, or instructions for transmitting one or more alerts based on the one or more resource allocation parameters satisfying one or more resource allocation thresholds.

The following provides an overview of aspects of the present disclosure:

Aspect 1: A method for resource scaling at an application server, comprising: monitoring a first plurality of user interactions with a plurality of web services to identify a plurality of web service elements and a plurality of API calls associated with the plurality of web service elements; generating, based at least in part on a machine learning analysis of the first plurality of user interactions, a graph database that comprises a plurality of mappings between the plurality of web service elements and the plurality of API calls, the plurality of mappings organized into user-based clusters; receiving natural language input that includes one or more instructions for scaling resources associated with the plurality of web services; processing the natural language input to identify one or more resource scaling rules from the one or more instructions; and adjusting one or more resource allocation parameters for the plurality of web services based at least in part on the plurality of mappings and the identified one or more resource scaling rules.

Aspect 2: The method of aspect 1, further comprising: training a generative AI model based at least in part on training data that comprises web service element patterns and API call patterns; wherein the machine learning analysis is performed with the trained generative AI model; and wherein the plurality of mappings are based at least in part on one or more recognized patterns in the first plurality of user interactions.

Aspect 3: The method of aspect 2, further comprising: adjusting the one or more resource allocation parameters based at least in part on the one or more recognized patterns.

Aspect 4: The method of any of aspects 2 through 3, further comprising: updating the training data based at least in part on the graph database.

Aspect 5: The method of any of aspects 1 through 4, further comprising: generating, using a generative AI model and based at least in part on the graph database, one or more predicted service element patterns, one or more predicted API call patterns, or any combination thereof that are associated with the plurality of web services; wherein adjusting the one or more resource allocation parameters for the plurality of web services is based at least in part on the one or more predicted service element patterns, the one or more predicted API call patterns, or any combination thereof.

Aspect 6: The method of any of aspects 1 through 5, further comprising: embedding, with a web application firewall application associated with the plurality of web services, a plurality of monitoring agents in the plurality of web services; wherein monitoring the first plurality of user interactions is performed using the plurality of monitoring agents.

Aspect 7: The method of any of aspects 1 through 6, further comprising: updating the graph database based at least in part on a second machine learning analysis of a second plurality of user interactions with the plurality of web services.

Aspect 8: The method of any of aspects 1 through 7, further comprising: adjusting one or more load balancing parameters for the plurality of web services based at least in part on the plurality of mappings and one or more one or more resources scaling rules.

Aspect 9: The method of any of aspects 1 through 8, further comprising: transmitting one or more alerts based at least in part on the one or more resource allocation parameters satisfying one or more resource allocation thresholds.

Aspect 10: An application server for resource scaling, comprising one or more memories storing processor-executable code, and one or more processors coupled with the one or more memories and individually or collectively operable to execute the code to cause the application server to perform a method of any of aspects 1 through 9.

Aspect 11: An application server for resource scaling, comprising at least one means for performing a method of any of aspects 1 through 9.

Aspect 12: A non-transitory computer-readable medium storing code for resource scaling, the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples. ” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for resource scaling at an application server, comprising:
monitoring a first plurality of user interactions with a plurality of web services to identify a plurality of web service elements and a plurality of application programming interface (API) calls associated with the plurality of web service elements;
generating, based at least in part on a machine learning analysis of the first plurality of user interactions, a graph database that comprises a plurality of mappings between the plurality of web service elements and the plurality of API calls, the plurality of mappings organized into user-based clusters;
receiving natural language input that includes one or more instructions for scaling resources associated with the plurality of web services;
processing the natural language input to identify one or more resource scaling rules from the one or more instructions; and
adjusting one or more resource allocation parameters for the plurality of web services based at least in part on the plurality of mappings and the identified one or more resource scaling rules.

2. The method of claim 1, further comprising:
training a generative artificial intelligence (AI) model based at least in part on training data that comprises web service element patterns and API call patterns;
wherein the machine learning analysis is performed with the trained generative AI model; and
wherein the plurality of mappings are based at least in part on one or more recognized patterns in the first plurality of user interactions.

3. The method of claim 2, further comprising:
adjusting the one or more resource allocation parameters based at least in part on the one or more recognized patterns.

4. The method of claim 2, further comprising:
updating the training data based at least in part on the graph database.

5. The method of claim 1, further comprising:
generating, using a generative artificial intelligence (AI) model and based at least in part on the graph database, one or more predicted service element patterns, one or more predicted API call patterns, or any combination thereof that are associated with the plurality of web services;
wherein adjusting the one or more resource allocation parameters for the plurality of web services is based at least in part on the one or more predicted service element patterns, the one or more predicted API call patterns, or any combination thereof.

6. The method of claim 1, further comprising:
embedding, with a web application firewall application associated with the plurality of web services, a plurality of monitoring agents in the plurality of web services, wherein monitoring the first plurality of user interactions is performed using the plurality of monitoring agents.

7. The method of claim 1, further comprising:
updating the graph database based at least in part on a second machine learning analysis of a second plurality of user interactions with the plurality of web services.

8. The method of claim 1, further comprising:
adjusting one or more load balancing parameters for the plurality of web services based at least in part on the plurality of mappings and one or more one or more resources scaling rules.

9. The method of claim 1, further comprising:
transmitting one or more alerts based at least in part on the one or more resource allocation parameters satisfying one or more resource allocation thresholds.

10. An application server for resource scaling, comprising:
one or more memories storing processor-executable code; and
one or more processors coupled with the one or more memories and individually or collectively operable to execute the code to cause the application server to:
monitor a first plurality of user interactions with a plurality of web services to identify a plurality of web service elements and a plurality of application programming interface (API) calls associated with the plurality of web service elements;
generate, based at least in part on a machine learning analysis of the first plurality of user interactions, a graph database that comprises a plurality of mappings between the plurality of web service elements and the plurality of API calls, the plurality of mappings organized into user-based clusters;
receive natural language input that includes one or more instructions for scaling resources associated with the plurality of web services;
process the natural language input to identify one or more resource scaling rules from the one or more instructions; and
adjust one or more resource allocation parameters for the plurality of web services based at least in part on the plurality of mappings and the identified one or more resource scaling rules.

11. The application server of claim 10, wherein the one or more processors are individually or collectively further operable to execute the code to cause the application server to:
train a generative artificial intelligence (AI) model based at least in part on training data that comprises web service element patterns and API call patterns, wherein the machine learning analysis is performed with the trained generative AI model, and wherein the plurality of mappings is based at least in part on one or more recognized patterns in the first plurality of user interactions.

12. The application server of claim 11, wherein the one or more processors are individually or collectively further operable to execute the code to cause the application server to:
adjust the one or more resource allocation parameters based at least in part on the one or more recognized patterns.

13. The application server of claim 11, wherein the one or more processors are individually or collectively further operable to execute the code to cause the application server to:
update the training data based at least in part on the graph database.

14. The application server of claim 10, wherein the one or more processors are individually or collectively further operable to execute the code to cause the application server to:
generate, using a generative artificial intelligence (AI) model and based at least in part on the graph database, one or more predicted service element patterns, one or more predicted API call patterns, or any combination thereof that are associated with the plurality of web services, wherein adjusting the one or more resource allocation parameters for the plurality of web services is based at least in part on the one or more predicted service element patterns, the one or more predicted API call patterns, or any combination thereof.

15. The application server of claim 10, wherein the one or more processors are individually or collectively further operable to execute the code to cause the application server to:
embed, with a web application firewall application associated with the plurality of web services, a plurality of monitoring agents in the plurality of web services, wherein monitor the first plurality of user interactions is performed using the plurality of monitoring agents.

16. The application server of claim 10, wherein the one or more processors are individually or collectively further operable to execute the code to cause the application server to:
update the graph database based at least in part on a second machine learning analysis of a second plurality of user interactions with the plurality of web services.

17. The application server of claim 10, wherein the one or more processors are individually or collectively further operable to execute the code to cause the application server to:
adjust one or more load balancing parameters for the plurality of web services based at least in part on the plurality of mappings and one or more one or more resources scaling rules.

18. The application server of claim 10, wherein the one or more processors are individually or collectively further operable to execute the code to cause the application server to:
transmit one or more alerts based at least in part on the one or more resource allocation parameters satisfying one or more resource allocation thresholds.

19. A non-transitory computer-readable medium storing code for resource scaling, the code comprising instructions executable by one or more processors to:
monitor a first plurality of user interactions with a plurality of web services to identify a plurality of web service elements and a plurality of application programming interface (API) calls associated with the plurality of web service elements;
generate, based at least in part on a machine learning analysis of the first plurality of user interactions, a graph database that comprises a plurality of mappings between the plurality of web service elements and the plurality of API calls, the plurality of mappings organized into user-based clusters;
receive natural language input that includes one or more instructions for scaling resources associated with the plurality of web services;
process the natural language input to identify one or more resource scaling rules from the one or more instructions; and
adjust one or more resource allocation parameters for the plurality of web services based at least in part on the plurality of mappings and the identified one or more resource scaling rules.

20. The non-transitory computer-readable medium of claim 19, wherein the instructions are further executable by the one or more processors to:
train a generative artificial intelligence (AI) model based at least in part on training data that comprises web service element patterns and API call patterns, wherein the machine learning analysis is performed with the trained generative AI model, and wherein the plurality of mappings are based at least in part on one or more recognized patterns in the first plurality of user interactions.
